(19) United States
(12) Patent Application Publication
(10) Pub. No.: US 2026/0260828 A1
(43) Pub. Date: Sep. 3, 2026

(54) SWITCH DEVICE

(71) Applicant: Alps Alpine Co., Ltd, Tokyo (JP)

(72) Inventor: Naoki HOSHI, Miyagi-ken (JP)

(21) Appl. No.: 19/653,799

(22) Filed: Apr. 21, 2026

Related U.S. Application Data
(63) Continuation of application No. PCT/JP2024/036000, filed on Oct. 8, 2024.

(30) Foreign Application Priority Data
Nov. 24, 2023 (JP) 2023-199097

(51) Int. Cl. H01H 13/22; H01H 13/14

(52) U.S. Cl. CPC H01H 13/22; H01H 13/14

(57) ABSTRACT

A switch device includes a snap-action mechanism including a movable member including a detecting section or a section to be detected provided on the other end side of the movable member and being configured to swing in a first direction relative to a fixed base to change a relative position between the detecting section and the section to be detected, a fixed member, a drive member having one end side engaged with the other end side of the movable member at a second pivot point, and a contact spring formed of a plate spring and having one end side engaged with the other end side of the drive member at a third pivot point and the other end side engaged with the fixed base at a fourth pivot point. A bent portion intersecting the drive member is provided between the one end and the other end of the contact spring.

### CLAIM OF PRIORITY

This application is a Continuation of International Application No. PCT/JP2024/036000 filed on October 8, 2024, which claims benefit of Japanese Patent Application No. 2023-199097 filed on November 24, 2023. The entire contents of each application noted above are hereby incorporated by reference.

### BACKGROUND OF THE INVENTION

### 1. FIELD OF THE INVENTION

The present invention relates to a switch device, and more particularly to a switch device that includes a snap-action mechanism.

### 2. DESCRIPTION OF THE RELATED ART

Japanese Unexamined Patent Application Publication No. 2013-239372 discloses a push-type switch device that achieves device miniaturization while extending the service life of a contact spring. The push-type switch device includes a housing having an accommodating space, an operation member configured to receive a pressing operation, a fixed contact terminal including a common contact terminal and a changeover contact terminal provided in the accommodating space, a movable contact configured to come into and out of contact with the changeover contact terminal, and a snap-action mechanism configured to drive the movable contact when the operation member is pressed to a predetermined position. The snap-action mechanism includes a conductor plate, a drive plate, and a contact spring. The contact spring and the drive plate are formed in an annular shape, and the common contact terminal extends through openings thereof.

In a switch device including such a snap-action mechanism, the number of components tends to increase, which may increase the device size. Accordingly, the space for arranging the components needs to be used efficiently to reduce the size of the switch device. In addition, the snap-action mechanism has a structure in which a movable member is instantaneously actuated by releasing energy stored in a spring, regardless of the operating speed of the operation member (such as an operation button). Therefore, measures are required to reduce impact noise caused by collision with a stopper and to ensure sufficient durability under repeated use.

### SUMMARY OF THE INVENTION

The present invention provides a switch device that includes a snap-action mechanism that achieves a longer service life of the switch while reducing the size of the device through efficient use of space for arranging components.

An aspect of the present invention provides a switch device including an operation member, a snap-action mechanism configured to be actuated in response to operation of the operation member, and a housing accommodating the snap-action mechanism. The snap-action mechanism includes a movable member including one of a detecting section and a section to be detected provided on the other end side of the movable member, the movable member being configured to swing in a first direction relative to a fixed base fixed to the housing with one end side serving as a first pivot point to change a relative position between the detecting section and the section to be detected, a fixed member including the other of the detecting section and the section to be detected, a drive member having one end side engaged with the other end side of the movable member at a second pivot point, and a contact spring formed of a plate spring, the contact spring having one end side engaged with the other end side of the drive member at a third pivot point located on the first pivot point side and the other end side engaged with the fixed base at a fourth pivot point located on the second pivot point side. A bent portion intersecting the drive member is provided between the one end and the other end of the contact spring.

According to such a configuration, the space for arranging the respective components of the switch device including the snap-action mechanism is efficiently used. In addition, by providing a bent portion in the contact spring, a sufficient spring length can be ensured even in a compact space, thereby extending the service life of the switch device.

In the switch device, the contact spring preferably has, between the one end and the other end, a second bent portion bent in a direction opposite to the bent portion. This configuration makes it easier to ensure a sufficient spring length of the contact spring.

In the switch device, it is preferable that the contact spring is provided in an annular shape when viewed in the first direction, and the drive member is disposed within an opening of the contact spring. In such a case, the drive member preferably has a bent portion at an outer peripheral portion facing an inner edge of the opening of the contact spring. By disposing the drive member within an opening of the contact spring, the structures of the drive member and the bent portion can be simplified. In addition, while ensuring the strength of the drive member, the width can be reduced, and thus the size of the switch device in the width direction can be reduced. In addition, the degree of freedom in designing the shape of the contact spring can be ensured.

In the switch device, the housing may have a stopper extending to come into contact with at least one of the movable member and the drive member, and the bent portion of the contact spring may intersect the stopper. By providing the bent portion of the contact spring to intersect the stopper within the housing, the bent portion of the contact spring is disposed in a dead space within the housing defined by the stopper. That is, the stopper and the contact spring are arranged in parallel within the housing, and a sufficient spring length of the contact spring can be ensured.

In the switch device, an end portion of the stopper preferably has an extending portion extending through the opening of the contact spring and extending to come into contact with the movable member. With this configuration, the stopper and the contact spring are arranged in parallel within the housing, and the bent portion of the contact spring can be enlarged by using a dead space within the housing defined by the stopper, thereby ensuring a sufficient spring length of the contact spring.

In the switch device, the housing may have a stopper extending to come into contact with the movable member, and an end portion of the stopper may have, between the first pivot point of the movable member and the other end side of the movable member, an extending portion extending to come into contact with the movable member. With this configuration, a contact portion of the movable member that comes into contact with the stopper in the snap-action mechanism is located closer to the first pivot point, thereby reducing the collision speed between the movable member and the stopper and suppressing impact noise.

In the switch device, a second stopper may be provided between the first pivot point and the other end side of the movable member and may be configured to come into contact with the movable member on a side opposite to a contact portion at which the movable member comes into contact with the stopper. With this configuration, a contact portion of the movable member that comes into contact with a second stopper in the snap-action mechanism is located closer to the first pivot point, thereby reducing the collision speed between the movable member and the second stopper and suppressing impact noise.

In the switch device, a contact portion that comes into contact with the stopper of at least one of the movable member and the drive member may include an elastic receiving section. By providing an elastic receiving portion in a contact portion at which the movable member comes into contact with the stopper, impact noise can be effectively suppressed.

In the switch device, one of the detecting section and the section to be detected may be a conductive movable contact, and the movable member and the movable contact may be formed from a common plate material having spring properties. With this configuration, the movable member and the movable contact can be integrally formed from a common plate material, thereby reducing the number of components.

According to the present invention, a switch device including a snap-action mechanism can be provided that achieves a longer service life of the switch while reducing the size of the device through efficient use of space for arranging components.

### BRIEF DESCRIPTION OF THE DRAWINGS

FIG. 1 is an external perspective view illustrating a switch device according to an embodiment;

FIG. 2 is an exploded perspective view illustrating the switch device according to the embodiment;

FIG. 3 is an exploded perspective view illustrating a snap-action mechanism;

FIG. 4 is a perspective view illustrating an assembled state of respective parts of the snap-action mechanism;

FIG. 5 is a perspective view illustrating a contact spring;

FIG. 6 is a cross-sectional view illustrating the switch device according to the embodiment;

FIG. 7 is a side view illustrating an initial position in a switching operation of the switch device according to the embodiment;

FIG. 8 is a side view illustrating a state prior to depression inversion in the switching operation of the switch device according to the embodiment;

FIG. 9 is a side view illustrating a state after the depression inversion in the switching operation of the switch device according to the embodiment;

FIG. 10 is a side view illustrating a state at the maximum depression position in the switching operation of the switch device according to the embodiment;

FIG. 11 is a side view illustrating a state prior to return inversion in switching of the switch device according to the embodiment; and

FIG. 12 is a side view illustrating a state after the return inversion in the switching operation of the switch device according to the embodiment.

### DESCRIPTION OF THE PREFERRED EMBODIMENTS

Hereinafter, an embodiment of the present invention will be described in detail with reference to the attached drawings. In the following descriptions, the same reference numerals are given to the same components and descriptions of the components described once will be omitted as appropriate.

### Switch Device

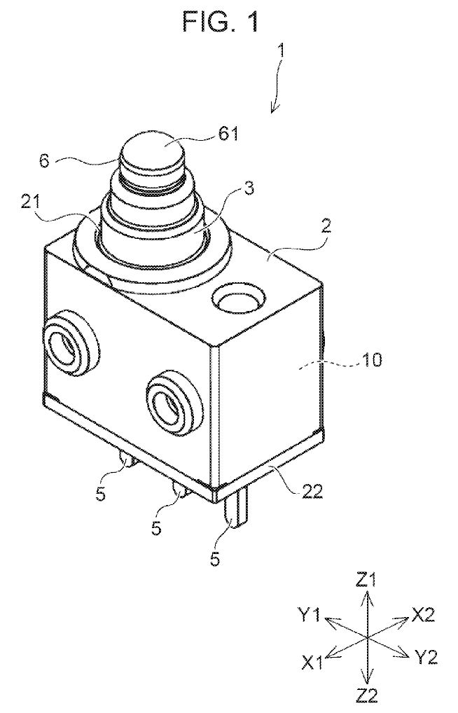

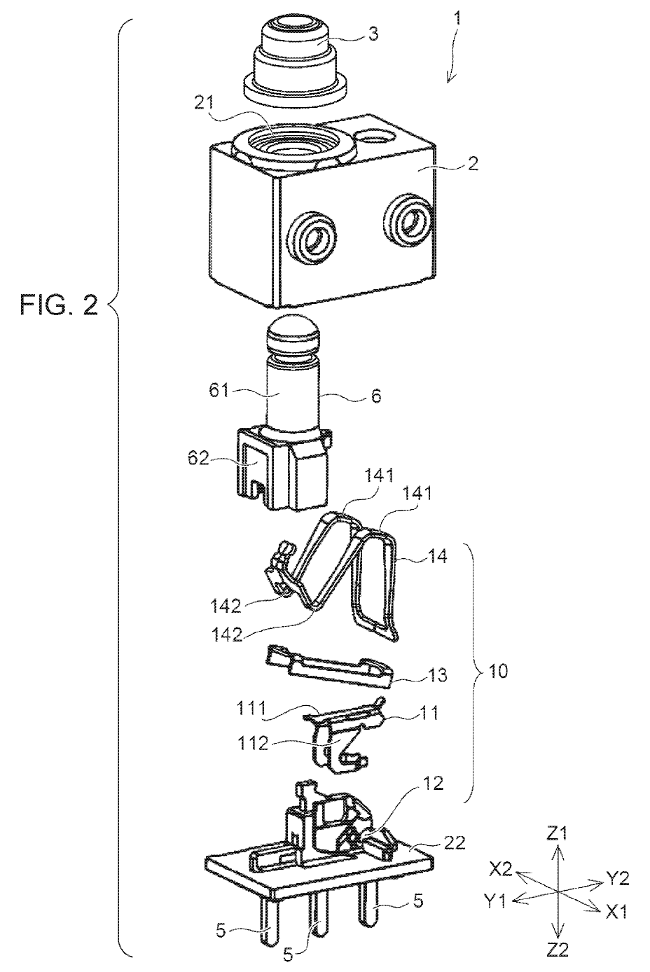

FIG. 1 is an external perspective view illustrating a switch device according to the embodiment. FIG. 2 is an exploded perspective view illustrating the switch device according the embodiment. A switch device 1 according to the embodiment is configured such that a portion of an operation member 6 protrudes from a part of an upper surface of a box-shaped housing 2 and is configured to receive a pressing operation by an operator or other person via the operation member 6 to switch a conduction state. Here, in the following description of the embodiment, a direction in which the operation member 6 moves during operation is referred to as a Z1–Z2 direction, one of directions orthogonal to the Z1–Z2 direction is referred to as an X1–X2 direction, and a direction orthogonal to both the Z1–Z2 direction and the X1–X2 direction is referred to as a Y1–Y2 direction. The Z1–Z2 direction is an example first direction. The X1–X2 direction is an example second direction. The Y1–Y2 direction is an example third direction. For convenience of description, the Z1–Z2 direction may also be referred to as an up–down direction, and the Z1 side may also be referred to as an upper side (up) and the Z2 side may also be referred to as a lower side (down).

The switch device 1 includes the housing 2 that is formed, for example, by molding an insulating resin material. The housing 2 has, for example, a box shape that has an opening on the lower side. A fixed base 22 is provided to close the opening to define an accommodating space in the housing 2. The operation member 6 is provided on the upper side of the housing 2 to protrude upward.

The operation member 6 includes a shaft section 61 that is movable in the up-down direction, and a guide section 62 that guides the movement of the shaft section 61. An upper end side of the shaft section 61 protrudes upward through a through hole 21 provided in the housing 2. The guide section 62 is fitted into the inside of the accommodation space of the housing 2 to restrict the movement of the shaft section 61 in the up-down direction. A cover 3 is mounted between the shaft section 61 and the through hole 21 to prevent the intrusion of foreign matter such as dust, water, or the like into the housing 2.

A snap-action mechanism 10 is provided on the fixed base 22, which is attached to close the opening on the lower side of the housing 2. The snap-action mechanism 10 mounted on the fixed base 22 is accommodated within the housing 2 and serves as a quick-action mechanism that switches a state of the switch device 1 in accordance with movement of the shaft section 61 of the operation member 6. The snap-action mechanism 10 includes a movable member 11, a fixed member 12, a drive member 13, and a contact spring 14.

### Snap-Action Mechanism

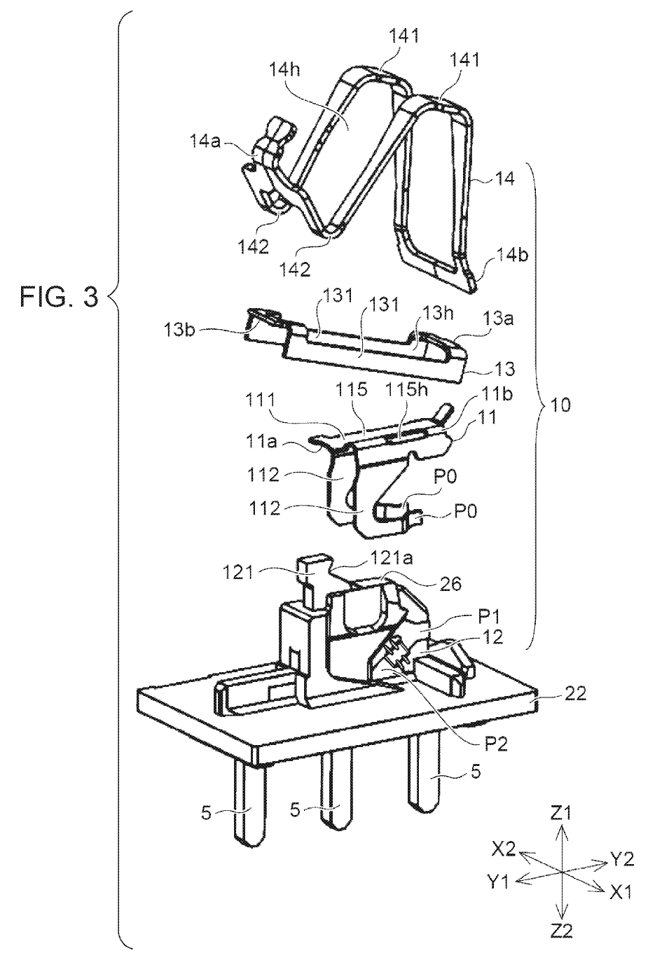

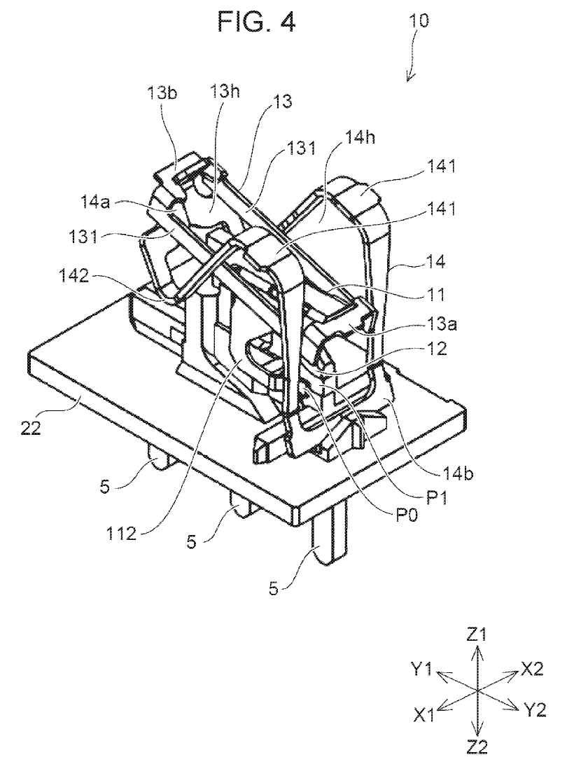

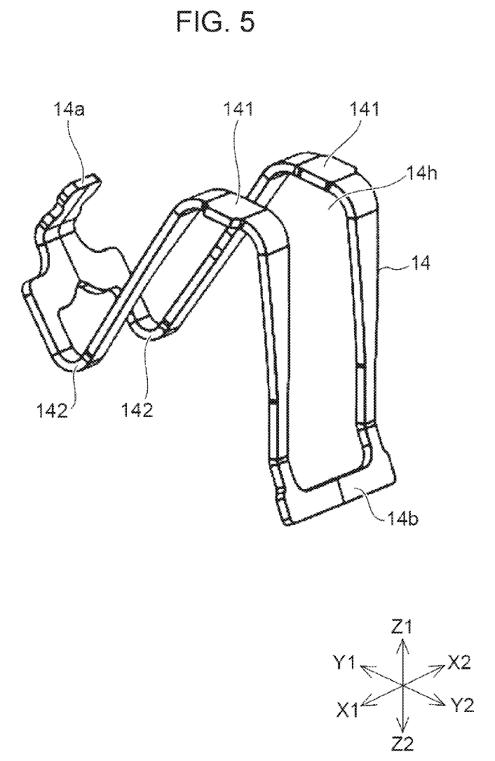

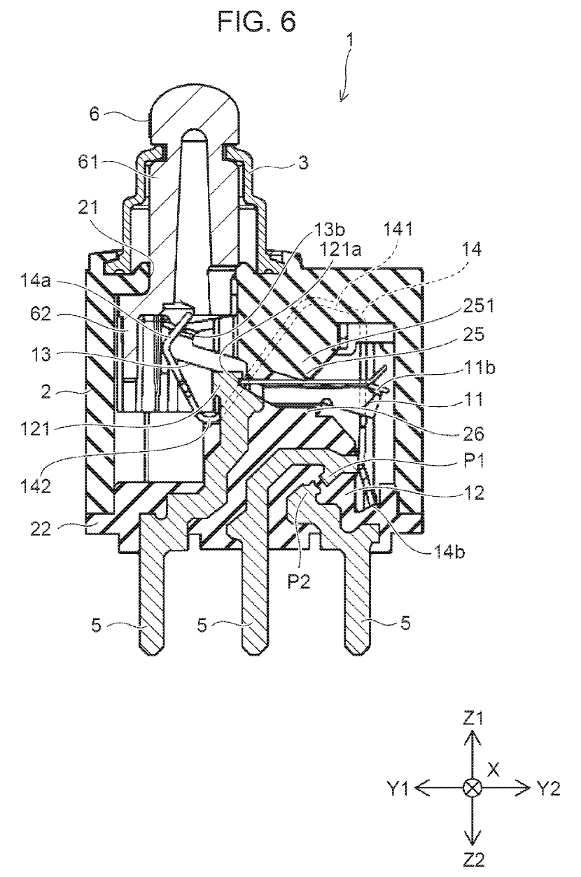

FIG. 3 is an exploded perspective view illustrating the snap-action mechanism. FIG. 4 is a perspective view illustrating an assembled state of respective parts of the snap-action mechanism. FIG. 5 is a perspective view illustrating the contact spring. FIG. 6 is a cross-sectional view illustrating the switch device according to the embodiment. FIG. 6 is a cross-sectional view illustrating the switch device 1 according to the embodiment taken along a YZ plane. In this embodiment, the snap-action mechanism 10 is described by taking, as an example, a sliding-type switching mechanism in which the movable member 11 slides relative to the fixed member 12 to switch contacts.

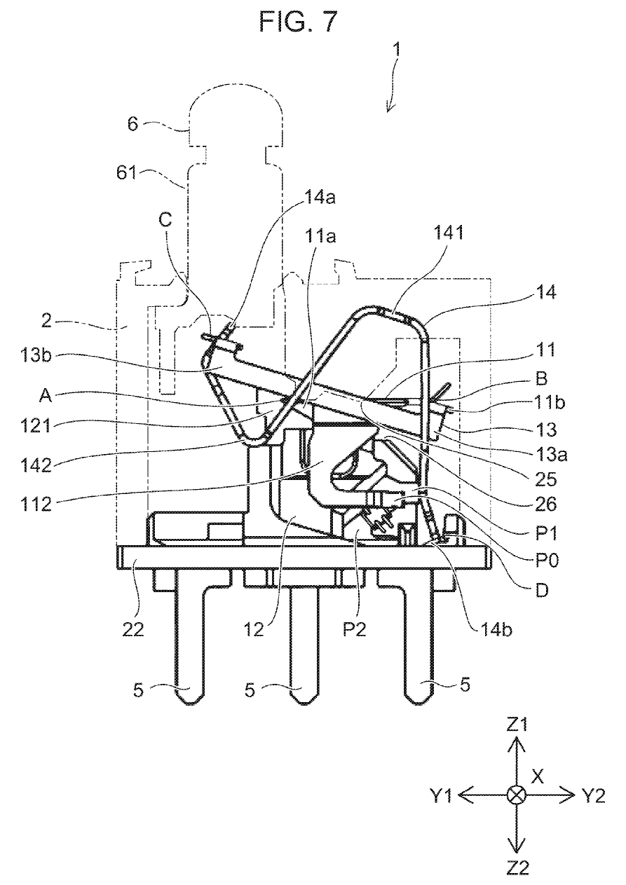

The movable member 11 of the snap-action mechanism 10 swings in the Z1–Z2 direction (first direction) relative to the fixed base 22, which is fixed to the housing 2, with one end 11a side that serves as a first pivot point A (see FIG. 7). A movable contact P0 is provided on the other end 11b side of the movable member 11. In this embodiment, the movable contact P0 is provided at a tip portion of an arm portion 112 that extends downward in a substantially L-shape from a middle portion of a body section 111 of the movable member 11. Two arm portions 112 extend from the body section 111. The two arm portions 112 are arranged side by side at a predetermined interval in the X1–X2 direction, and the movable contacts P0 are provided at the respective tip portions of the arm portions 112. Accordingly, the fixed member 12 is sandwiched between the two arm portions 112, and the movable contacts P0 of the respective arm portions 112 are brought into sliding contact with both sides of the fixed member 12. The movable member 11 is formed, for example, by sheet-metal processing of a plate material that has electrical conductivity and spring properties. That is, the movable member 11 and the movable contacts P0 are formed from a common plate material that has electrical conductivity and spring properties.

A first contact P1 and a second contact P2, which are fixed contacts, are provided in the fixed member 12. The fixed member 12 comprises an insulating material, and the first contact P1 and the second contact P2 are electrically insulated from each other. In addition, a common contact terminal 121 is provided in the fixed member 12. The common contact terminal 121 comprises a conductive material. Each of the first contact P1, the second contact P2, and the common contact terminal 121 is electrically connected to a corresponding external connection terminal 5 that is provided to the fixed base 22 through the fixed member 12.

More specifically, the common contact terminal 121 has a notch portion 121a, which will be described below, and is a part of the external connection terminal 5 located at the left end (on the Y1 side in the Y1–Y2 direction) in FIG. 6. The notch portion 121a is exposed from the fixed member 12, and the common contact terminal 121 is electrically connected to the external connection terminal 5 located at the left end. The first contact P1 is a part of the external connection terminal 5 located at the center in FIG. 6. The first contact P1 is exposed on both sides of the fixed member 12 in the X1-X2 direction, and the first contact P1 is electrically connected to the external connection terminal 5 located at the center. The second contact P2 is a part of the external connection terminal 5 located at the right end (on the Y2 side in the Y1–Y2 direction) in FIG. 6. The second contact P2 is exposed on both sides of the fixed member 12 in the X1-X2 direction, and the second contact P2 is electrically connected to the external connection terminal 5 located at the right end. The common contact terminal 121, the first contact P1, and the second contact P2 are embedded in the fixed member 12 and electrically insulated from one another.

The common contact terminal 121 has the notch portion 121a. The one end 11a side of the movable member 11 engages with the notch portion 121a and the one end 11a side and the notch portion 121a are electrically connected to each other. The one end 11a side of the movable member 11 engaged with the notch portion 121a serves as the first pivot point A (see FIG. 7), and the other end 11b side of the movable member 11 swings. As the other end 11b side of the movable member 11 swings, the electrical connection state between the movable contact P0 and the first contact P1 and the second contact P2 is switched. That is, either the first contact P1 and the second contact P2, which are fixed contacts, or the movable contact P0 serves as a detecting section, while the other serves as a section to be detected.

The drive member 13 is formed from, for example, a metal plate material and is a member that extends in the Y1–Y2 direction. One end 13a side of the drive member 13 is engaged with the other end 11b side of the body section 111 of the movable member 11. The one end 13a side of the drive member 13 serves as a second pivot point B (see FIG. 7) in a swinging operation of the drive member 13.

The contact spring 14 is a leaf spring, and one end 14a side thereof is engaged with the other end 13b side of the drive member 13. The one end 14a side of the contact spring 14 serves as a third pivot point C (see FIG. 7) located on the first pivot point A side. The other end 14b side of the contact spring 14 is engaged with the fixed base 22. The other end 14b side of the contact spring 14 serves as a fourth pivot point D (see FIG. 7) located on the second pivot point B side.

In such a contact spring 14, a bent portion 141 that intersects the drive member 13 is provided between the one end 14a and the other end 14b of the contact spring 14. The contact spring 14 preferably has a second bent portion 142 that is bent in a direction opposite to the bent portion 141 between the one end 14a and the other end 14b of the contact spring 14.

That is, the contact spring 14 is formed in a substantially S-shape when viewed in the X1–X2 direction. In a state in which the respective parts are assembled as the snap-action mechanism 10, the bent portion 141 is disposed to intersect the drive member 13. When the second bent portion 142 is provided, the second bent portion 142 is also disposed to intersect the drive member 13 from a side opposite to the bent portion 141. The bent portion 141 provided in the contact spring 14 enables a sufficient spring length to be ensured even in a limited space. In addition to the bent portion 141, the second bent portion 142 enables a greater spring length of the contact spring 14 to be ensured.

The contact spring 14 is provided in an annular shape when viewed in the Z1–Z2 direction (first direction). In a state in which the respective parts of the snap-action mechanism 10 are assembled, the drive member 13 is preferably disposed within an opening 14h of the contact spring 14, that is, inside the annular shape of the contact spring 14 when viewed in the Z1–Z2 direction (first direction). Such an arrangement enables the drive member 13 to operate within the annular shape of the contact spring 14, thereby simplifying the configuration of the drive member 13 and the contact spring 14 and enabling efficient use of the space for arranging the drive member 13 and the contact spring 14. In addition, the degree of freedom in designing the shape of the contact spring 14 can be ensured.

The drive member 13, which extends in the Y1–Y2 direction, preferably has bent portions 131 at outer peripheral portions that face an inner edge of the opening 14h of the contact spring 14. The bent portions 131 are provided on both sides of the drive member 13 in the X1–X2 direction and are bent, for example, toward the Z2 side in the Z1–Z2 direction. With this configuration, while ensuring the strength of the drive member 13, the width (the length in the X1–X2 direction) can be reduced, and thus the size of the switch device 1 in the width direction can be reduced.

The drive member 13 may be provided in an annular shape when viewed in the Z1–Z2 direction (first direction). In a state in which the respective parts of the snap-action mechanism 10 are assembled, the movable member 11 is preferably disposed within an opening 13h of the drive member 13, that is, inside the annular shape of the drive member 13 when viewed in the Z1–Z2 direction (first direction). Such an arrangement enables the movable member 11 to operate within the annular shape of the drive member 13, thereby enabling efficient use of the space for arranging the movable member 11 and the drive member 13.

### Stopper

As illustrated in FIG. 6, in the switch device 1, the housing 2 has a stopper 25 that extends to come into contact with at least one of the movable member 11 and the drive member 13. In this embodiment, the stopper 25 extends toward the Z2 side (lower side) in the Z1–Z2 direction within the housing 2, and comes into contact with the movable member 11. When the movable member 11 swings in the Z1–Z2 direction, a position on the Z1 side (upper side) in the Z1–Z2 direction is restricted by the stopper 25. That is, the movable member 11 moves toward the Z1 side (upper side) in the Z1–Z2 direction, and further upward movement is restricted at a position at which the movable member 11 contacts the stopper 25.

In the switch device 1 having such a stopper 25, the bent portion 141 of the contact spring 14 intersects the stopper 25. An end portion of the stopper 25 preferably has an extending portion 251 that extends through the opening 14h (see FIG. 5) of the contact spring 14 and extends to come into contact with the movable member 11. This configuration enables the bent portion 141 of the contact spring 14 to be disposed in a dead space within the housing 2 defined by the stopper 25. Accordingly, the stopper 25 and the contact spring 14 are arranged in parallel in the X1–X2 direction within the housing 2, and a sufficient spring length of the contact spring 14 can be ensured.

The extending portion 251 of the stopper 25 is preferably provided at a position at which the extending portion 251 comes into contact with the movable member 11 between the first pivot point A (see FIG. 7) of the movable member 11 and the other end 11b side of the movable member 11. With this configuration, the contact portion of the movable member 11 that comes into contact with the stopper 25 in the snap-action mechanism 10 is located closer to the first pivot point A, thereby reducing the collision speed between the movable member 11 and the stopper 25 and suppressing impact noise.

Further, in order to effectively suppress impact noise generated when the movable member 11 contacts the stopper 25, an elastic receiving portion 115 (see FIG. 3) may be provided at the contact portion of the movable member 11 that comes into contacts with the stopper 25. The elastic receiving portion 115 may include an elastic member such as rubber (not illustrated) provided on the contact portion at which the movable member 11 comes into contact with the stopper 25, or an opening 115h (see FIG. 3) formed in a portion of the movable member 11 to reduce the rigidity of the contact portion at which the movable member 11 comes into contact with the stopper 25. In this embodiment, the elastic receiving portion 115 is provided in the body section 111 of the movable member 11 by forming the opening 115h in a portion between the body section 111 and the arm portions 112 of the movable member 11. With this configuration, impact noise generated when the stopper 25 and the contact portion contact can be more effectively suppressed.

In addition, between the first pivot point A (see FIG. 7) and the other end 11b side of the movable member 11, a second stopper 26 (see FIGS. 6 and 7) may be provided so as to come into contact with the movable member 11 on a side opposite to the contact portion at which the movable member 11 comes into contact with the stopper 25. The second stopper 26 is provided on the Z1 side (upper side) in the Z1–Z2 direction of an insulating portion of the fixed member 12. The second stopper 26 is formed, for example, in a convex shape that protrudes upward. By providing the second stopper 26 in addition to the stopper 25, position restriction is performed in both upward and downward directions during swinging of the movable member 11.

In the above example, the stopper 25 and the second stopper 26 are configured to come into contact with the movable member 11. However, the stopper 25 and the second stopper 26 may be configured to come into contact with the drive member 13.

### Switching Operation of Switch Device

Next, a switching operation of the switch device 1 according to the embodiment will be described. FIGS. 7 to 12 are side views illustrating the switching operation of the switch device according to the embodiment. For convenience of explanation, the housing 2 and the operation member 6 are indicated by chain double-dashed lines in FIGS. 7 to 12.

First, in the initial position illustrated in FIG. 7, the operation member 6 is urged toward the Z1 side (upper side) in the Z1–Z2 direction by the biasing force of the contact spring 14, and the shaft section 61 of the operation member 6 protrudes upward from the through hole 21 (see FIG. 1) of the housing 2. In this state, the one end 14a side of the contact spring 14 rotates upward about the fourth pivot point D, which is the other end 14b side, as a fulcrum. Accordingly, the other end 13b side of the drive member 13 rotates upward about the second pivot point B, which is the one end 13a side, as a fulcrum. The other end 11b side of the movable member 11 rotates upward about the first pivot point A, which is the one end 11a side, as a fulcrum. As a result, the movable contacts P0 provided on the other end 11b side of the movable member 11 are in contact with the first contact P1 of the fixed member 12. Accordingly, the common contact terminal 121 and the first contact P1 are electrically connected through the movable member 11, thereby forming a circuit in which the external connection terminal 5 at the left end (on the Y1 side in the Y1–Y2 direction) and the external connection terminal 5 at the center in FIG. 7 are electrically connected.

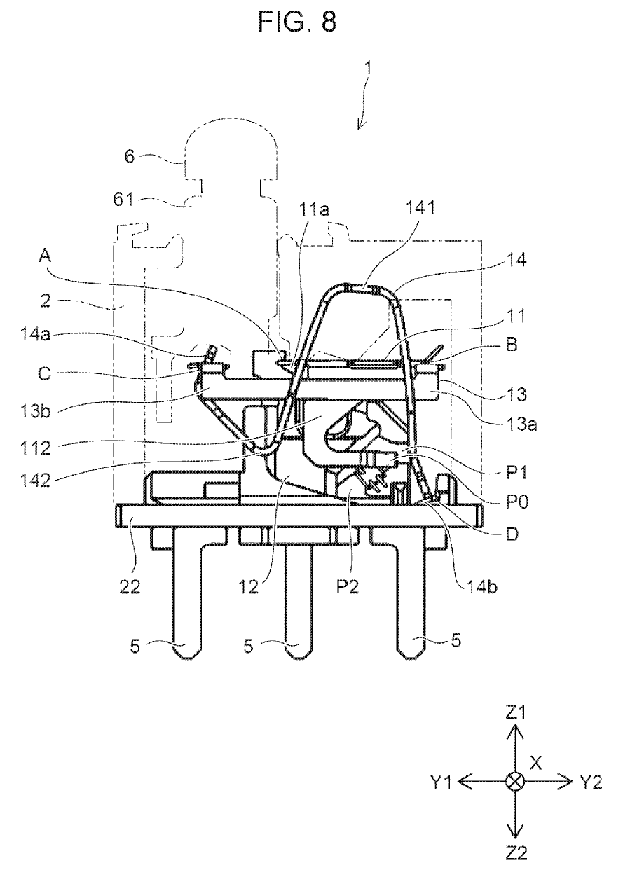

Next, as illustrated in FIG. 8, when the operation member 6 is pushed toward the Z2 side (lower side) in the Z1–Z2 direction, the mechanism shifts to a state prior to depression inversion. In this state, when the operation member 6 is depressed, the one end 14a side of the contact spring 14 and the other end 13b side of the drive member 13 are pushed downward. The contact spring 14 rotates downward about the fourth pivot point D as a fulcrum, and the drive member 13 rotates downward about the second pivot point B as a fulcrum. However, in this state, the movable member 11 does not rotate, and the contact state between the movable contact P0 and the first contact P1 is maintained.

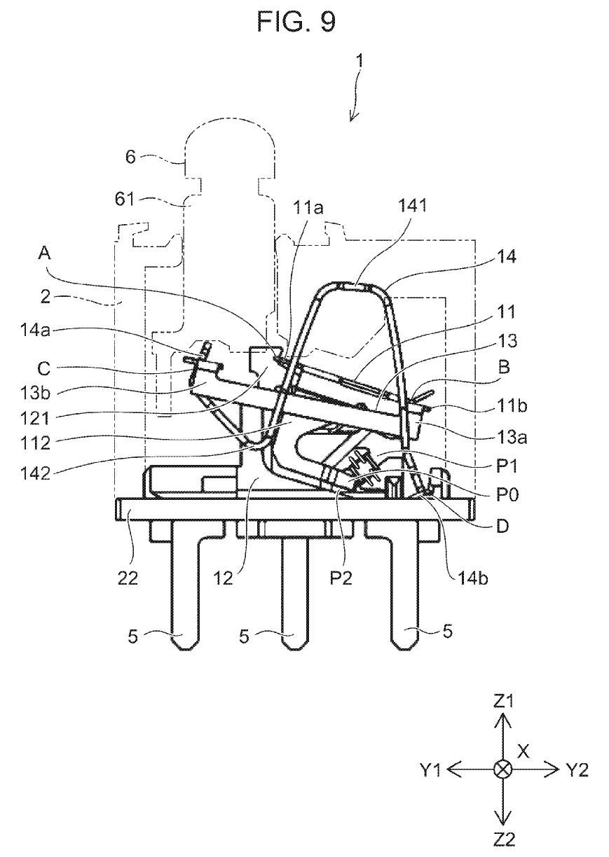

Next, when the operation member 6 is pushed slightly beyond the state prior to the depression inversion illustrated in FIG. 8, the mechanism shifts to a state after the depression inversion, as illustrated in FIG. 9. That is, in this state, the one end 13a side of the drive member 13 rotates downward about the third pivot point C, which is the other end 13b side, as a fulcrum, under the urging force of the contact spring 14. As a result, the other end 11b side of the movable member 11, which is engaged with the one end 13a side of the drive member 13, rapidly rotates downward, thereby the connection of the movable contact P0 is instantaneously switched from the first contact P1 to the second contact P2. Accordingly, electrical conduction between the common contact terminal 121 and the second contact P2 is instantaneously established through the movable member 11, thereby forming a circuit in which the external connection terminal 5 at the left end (on the Y1 side in the Y1–Y2 direction) in FIG. 8 and the external connection terminal 5 at the right end (on the Y2 side in the Y1–Y2 direction) are electrically connected. After this switching operation, the movable member 11 collides with the second stopper 26 (see FIG. 7), and thus the downward movement of the movable member 11 is restricted.

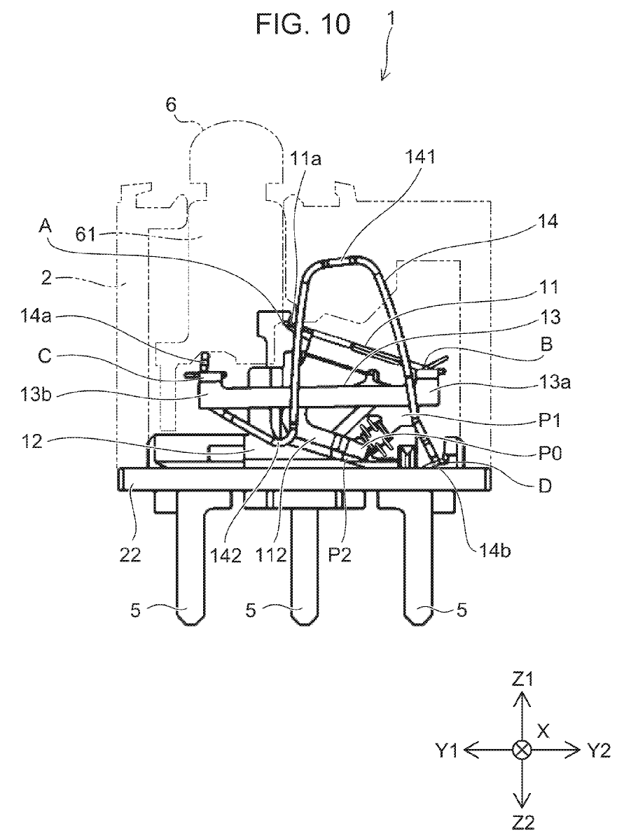

Next, when the operation member 6 is further pushed from the state after the depression inversion illustrated in FIG. 9, the mechanism shifts to the maximum depression position illustrated in FIG. 10. In this state, the position of the movable member 11 remains unchanged, while the one end 14a side of the contact spring 14 and the other end 13b side of the drive member 13 are pushed downward. As a result, the other end 13b side of the drive member 13 rotates downward about the second pivot point B, which is the one end 13a side, as a fulcrum.

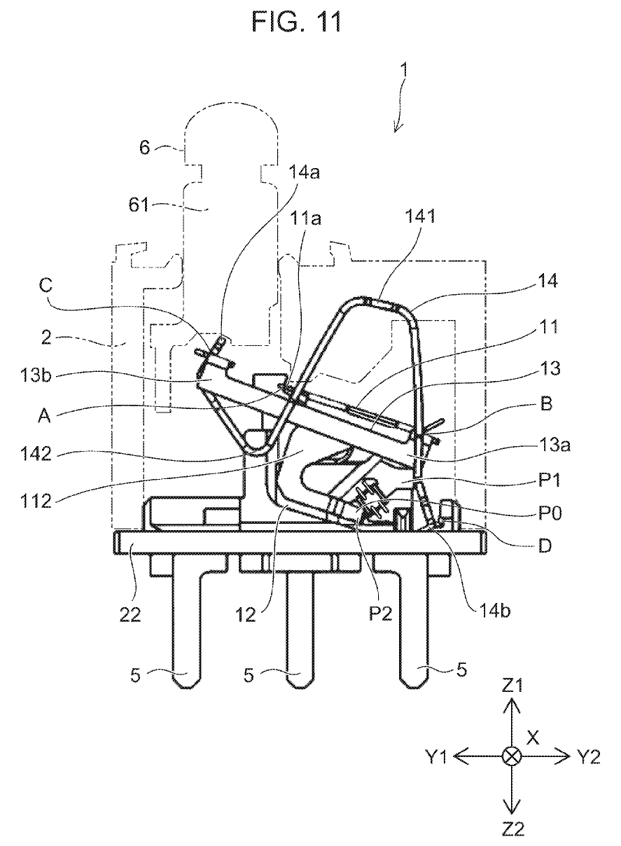

Next, when the depressing force applied to the operation member 6 is released from the state at the maximum depression position illustrated in FIG. 10, the mechanism shifts to a state prior to the return inversion, as illustrated in FIG. 11. In this state, the one end 14a side of the contact spring 14 and the other end 13b side of the drive member 13 rotate upward under the urging force of the contact spring 14, thereby pushing the operation member 6 upward. However, the movable member 11 does not rotate, and the contact state between the movable contact P0 and the second contact P2 is maintained.

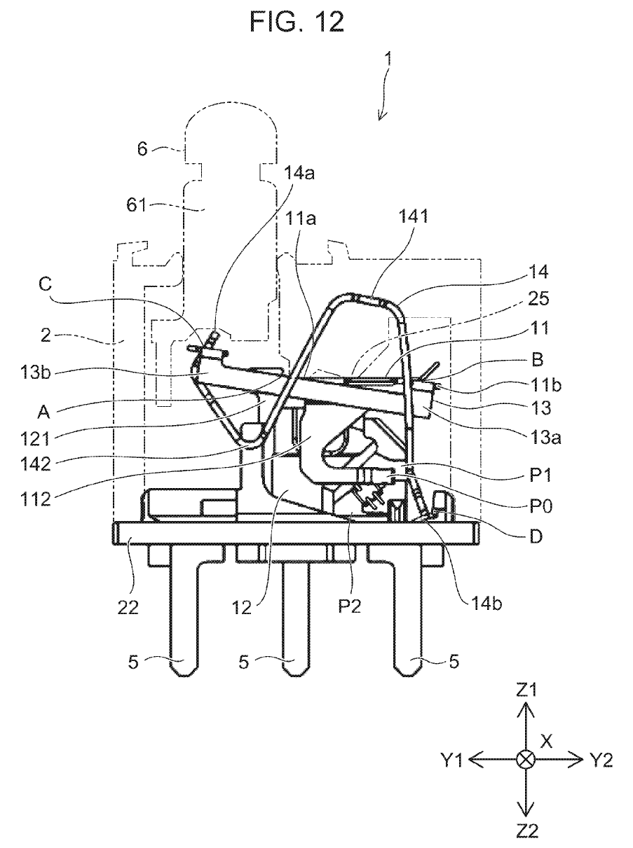

Next, when the state prior to the return inversion illustrated in FIG. 11 is exceeded, the mechanism shifts to a state after the return inversion, as illustrated in FIG. 12. That is, in this state, the one end 13a side of the drive member 13 rotates upward about the third pivot point C, which is the other end 13b side, as a fulcrum, under the urging force of the contact spring 14. As a result, the other end 11b side of the movable member 11, which is engaged with the one end 13a side of the drive member 13, rapidly rotates upward, thereby the connection of the movable contact P0 is instantaneously switched from the second contact P2 to the first contact P1. Accordingly, electrical conduction between the common contact terminal 121 and the first contact P1 is instantaneously established through the movable member 11, thereby forming a circuit in which the external connection terminal 5 at the left end (on the Y1 side in the Y1–Y2 direction) and the external connection terminal 5 at the center in FIG. 12 are electrically connected. After this switching operation, the movable member 11 collides with the stopper 25, and thus the upward movement of the movable member 11 is restricted.

With the snap-action mechanism 10 described above, the switch device 1 can instantaneously switch a conduction state by switching the connection of the movable contact P0 between the fixed contacts (the first contact P1 and the second contact P2). In the snap-action mechanism 10, the contact spring 14 is provided with the bent portion 141 and the second bent portion 142 arranged to intersect the drive member 13. Accordingly, even in a limited space, the sufficient spring length can be ensured, thereby enabling both miniaturization of the switch device 1 and an extended service life. In addition, the movable member 11 that comes into contact with the stopper 25 and the second stopper 26 is provided with the elastic receiving portion 115 (see FIG. 3). With this configuration, impact noise generated when the movable member 11 contacts the stopper 25 and the second stopper 26 can be suppressed, thereby achieving quieter operation during an instantaneous switching operation of the snap-action mechanism 10.

Although the embodiment has been described above, the present invention is not limited to this embodiment. For example, contact between the movable contact P0 and the first contact P1 and the second contact P2 may be sliding contact or abutting contact. In addition, as the detecting section and the section to be detected, the contact-type detecting section and section to be detected that have the movable contact P0 and the first contact P1 and the second contact P2 have been described; however, other types of detecting sections and sections to be detected may be used, such as an optical type (a light-emitting/receiving section and a shielding plate) or a magnetic type (a magnetic sensor and a magnetic field generating means). In such cases, one of the detecting section and the section to be detected may be provided in the movable member 11, and the other of the detecting section and the section to be detected may be provided in the fixed member 12, such that the relative position between the detecting section and the section to be detected changes as the movable member 11 swings. In addition, only one of the first contact P1 and the second contact P2 may be provided while the other is non-conductive, such that the conduction state can be switched between an on state and an off state. In addition, although the fixed base 22 has been described as a separate member that closes the opening on the lower side of the housing 2, the fixed base 22 may alternatively be integrally formed with the bottom portion on the lower side of the housing 2 in advance, such that the opening formed on the upper side of the housing 2 is closed with a lid. It is to be understood that any component may be added, any of the above-described components may be omitted, or any of the above-described designs may be modified, or any features of the configurations according to the embodiment may be combined appropriately by a person skilled in the art without departing from the scope of the invention, and such modifications are included within the scope of the invention.

What is claimed is:

1. A switch device comprising: an operation member; a snap-action mechanism configured to be actuated in response to operation of the operation member; and a housing accommodating the snap-action mechanism, wherein the snap-action mechanism includes a movable member including one of a detecting section and a section to be detected provided on the other end side of the movable member, the movable member being configured to swing in a first direction relative to a fixed base fixed to the housing with one end side serving as a first pivot point to change a relative position between the detecting section and the section to be detected; a fixed member including the other of the detecting section and the section to be detected; a drive member having one end side engaged with the other end side of the movable member at a second pivot point; and a contact spring formed of a plate spring, the contact spring having one end side engaged with the other end side of the drive member at a third pivot point located on the first pivot point side and the other end side engaged with the fixed base at a fourth pivot point located on the second pivot point side, wherein a bent portion intersecting the drive member is provided between the one end and the other end of the contact spring.

2. The switch device according to claim 1, wherein the contact spring has, between the one end and the other end, a second bent portion bent in a direction opposite to the bent portion.

3. The switch device according to claim 1, wherein the contact spring is provided in an annular shape when viewed in the first direction, and the drive member is disposed within an opening of the contact spring.

4. The switch device according to claim 3, wherein the drive member has a bent portion at an outer peripheral portion facing an inner edge of the opening of the contact spring.

5. The switch device according to claim 1, wherein the housing has a stopper extending to come into contact with at least one of the movable member and the drive member, and the bent portion of the contact spring intersects the stopper.

6. The switch device according to claim 5, wherein an end portion of the stopper has an extending portion extending through the opening of the contact spring and extending to come into contact with the movable member.

7. The switch device according to claim 1, wherein the housing has a stopper extending to come into contact with the movable member, and an end portion of the stopper has, between the first pivot point of the movable member and the other end side of the movable member, an extending portion extending to come into contact with the movable member.

8. The switch device according to claim 7, wherein a second stopper is provided between the first pivot point and the other end side of the movable member and is configured to come into contact with the movable member on a side opposite to a contact portion at which the movable member comes into contact with the stopper.

9. The switch device according to claim 7, wherein a contact portion that comes into contact with the stopper of at least one of the movable member and the drive member includes an elastic receiving section.

10. The switch device according to claim 1, wherein one of the detecting section and the section to be detected is a conductive movable contact, and the movable member and the movable contact are formed from a common plate material having spring properties.
